(19) United States
(12) Patent Application Publication
(10) Pub. No.: US 2024/0365836 A1
(43) Pub. Date: Nov. 7, 2024

(54) BAKING DEVICE WITH UNIFORM HEATING APPLICATION

(71) Applicant: Pro-Iroda Industries, Inc., Taichung City (TW)

(72) Inventor: Zhao Quan KE, Taichung City (TW)

(21) Appl. No.: 18/623,542

(22) Filed: Apr. 1, 2024

(30) Foreign Application Priority Data
May 2, 2023 (TW) 112116298

(51) Int. Cl. A23N 12/10; A23N 12/12; H05B 3/00

(52) U.S. Cl. CPC A23N 12/10; A23N 12/125; H05B 3/0038

(57) ABSTRACT

A baking device with uniform heating application comprises a frame, a roller assembly, and a heater. The roller assembly is supported by the frame. The roller assembly comprises a rotatable inner cylinder and a rotatable outer cylinder. The inner cylinder defines a plurality of first through holes that connect inner and outer surfaces of the inner cylinder. The inner cylinder encloses a hollow space that forms a heating zone. The outer cylinder has a plurality of second through holes that connect inner and the outer surfaces of the outer cylinder. The outer cylinder is arranged circumferentially outside and surrounds the inner cylinder. A baking zone of the baking device is formed between the inner and outer cylinders. The heater connected to the frame and arranged in the heating zone.

### BACKGROUND OF THE INVENTION

The present invention mainly discloses a baking device and, particularly, to a baking device with uniform heating application.

TW Pat. No. M562590 discloses a baking machine comprising a metal drum housed in a polygonal outer cylinder and an electric energy induction heating conductor coil disposed adjacent to the top or side of the metal drum. As the electric energy induction heating conductor coil conducts electricity and senses the metal drum, electric energy induction heating heats the metal drum to bake and heat baked goods in the drum.

The baking device may apply heat relatively more uniformly compared to a direct heating method, but only specific areas on the surface of the metal drum are heated. Thus, the metal drum is rotated to roast the baked goods, and whether they come into contact with the heating surface will affect the roasting condition of the coffee beans. Therefore, it is still difficult to ensure that every coffee bean is heated evenly.

The present invention is, therefore, intended to obviate or at least alleviate the problems encountered in the prior art.

### SUMMARY OF THE INVENTION

A baking device with uniform heating application comprises a frame, a roller assembly, and a heater. The roller assembly is supported by the frame. The roller assembly comprises an inner cylinder and an outer cylinder rotatable about a virtual rotation axis. The inner cylinder defines a plurality of first through holes, and the first through holes extend through inner and outer surfaces of the inner cylinder, connecting the inner and outer surfaces of the inner cylinder. The inner cylinder encloses a hollow space that forms a heating zone. The outer cylinder has a plurality of second through holes. The second through holes extend through inner and outer surfaces of the outer cylinder, connecting the inner and the outer surfaces of the outer cylinder. The outer cylinder is arranged circumferentially outside and surrounds the inner cylinder. A baking zone of the baking device is formed between an outside of the inner cylinder and an inside of the outer cylinder. The heater connected to the frame and arranged in the heating zone.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the public generally, and especially scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF DRAWINGS

FIG. 1 is a perspective view of a baking device with uniform heating application according to the present invention.

FIG. 2 is an exploded perspective view of the baking device of FIG. 1.

FIG. 3 is a cross-sectional view of the baking device of FIG. 1 along the axial direction of the rotation axis.

FIG. 4 is a cross-sectional view of the baking device of FIG. 1 along the radial direction of the rotation axis.

Before any embodiments of the invention are explained in detail, it is to be understood that the invention is not limited in its application to the details of construction and the arrangement of components set forth in the following description or illustrated in the following drawings. The invention is capable of other embodiments and of being practiced or carried out in various ways. Also, it is to be understood that the phraseology and terminology used herein are for the purpose of description and should not be regarded as limiting.

### DETAILED DESCRIPTION OF THE INVENTION

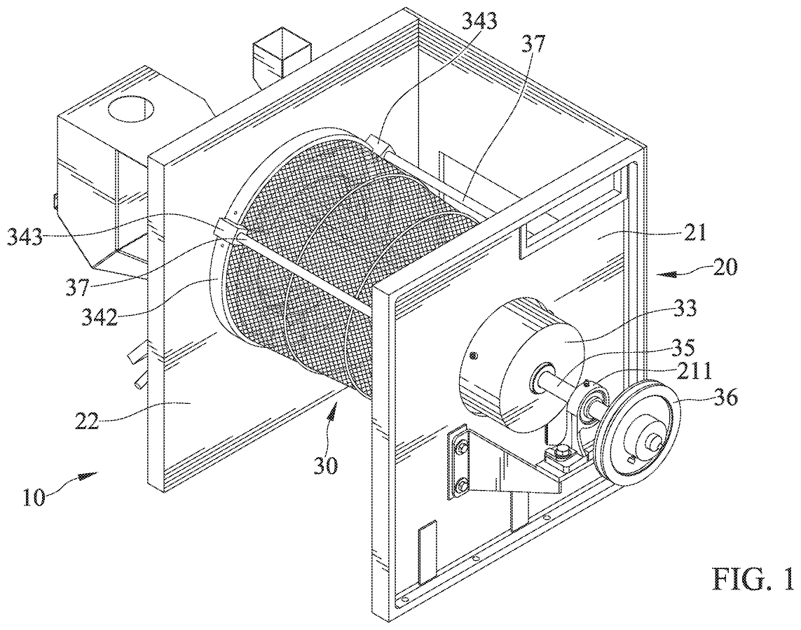

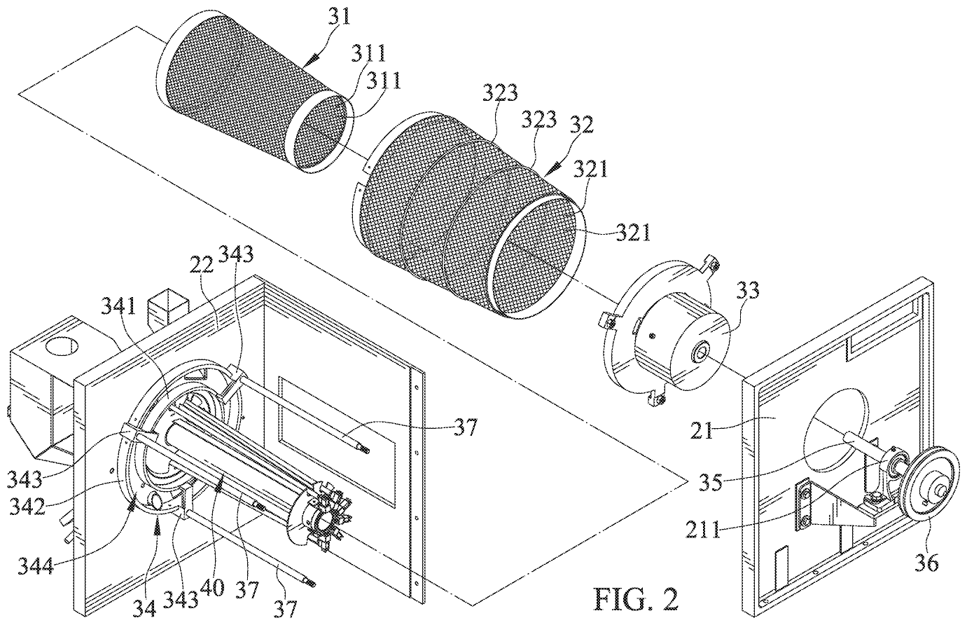

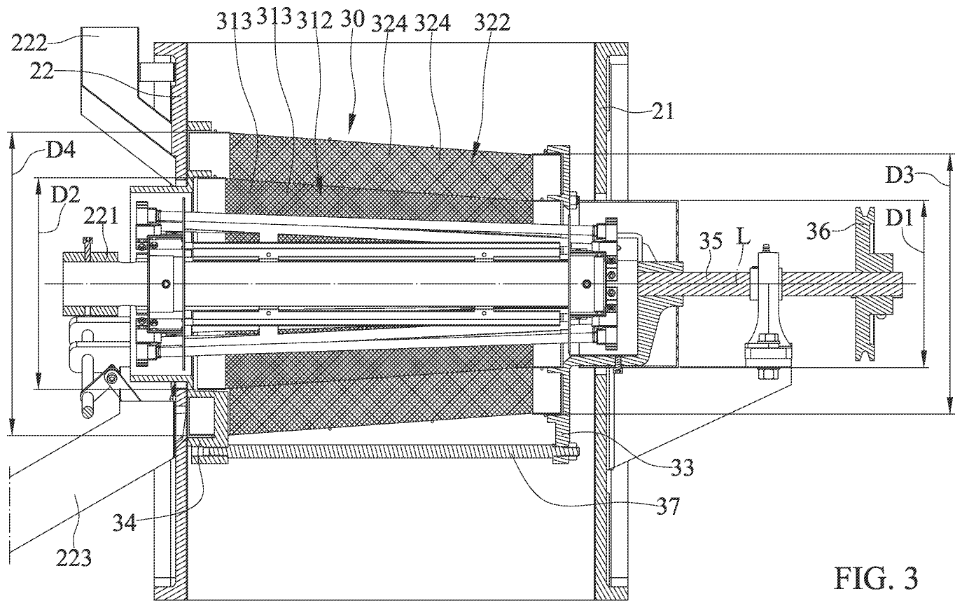

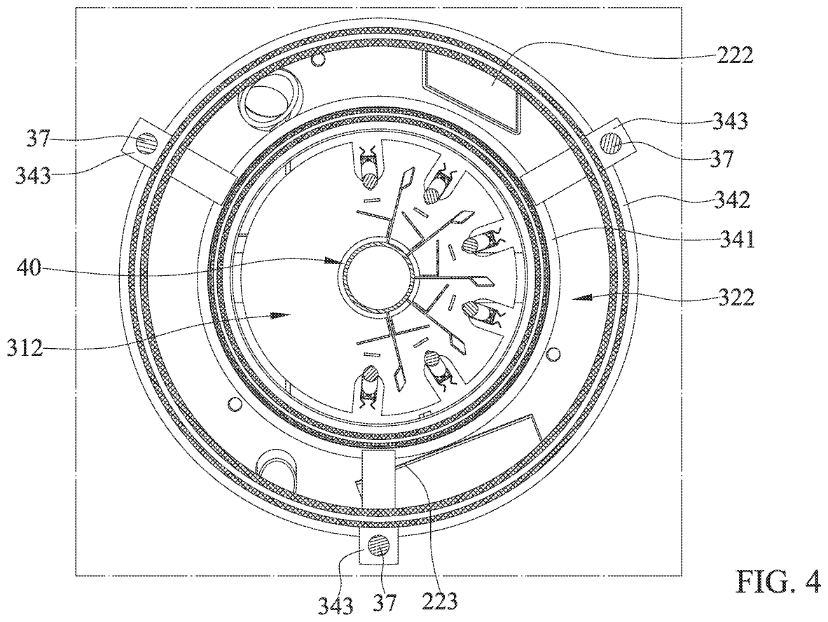

FIGS. 1-4 show a baking device 10 with uniform heating application according to the present invention, which comprises a frame 20, a roller assembly 30, and a heater 40.

The frame 20 is provided with a first support portion 21 and a second support portion 22 that support the roller assembly 30. The roller assembly 30 is disposed between the first and the second support portions 21 and 22. The first support portion 21 comprises a shaft seat 211 connected thereto, and the shaft seat 211 and the second support portion 22 are disposed on opposite sides of the first support portion 21. The second support portion 22 comprises a heater seat 221 connected thereto, and the heater seat 221 and the first support portion 21 are disposed on the opposite sides of the second support portion 22. A bean load pipe 222 and a bean discharge pipe 223 are connected to the second support portion 22.

The roller assembly 30 is supported by the frame 20. The roller assembly 30 comprises an inner cylinder 31, an outer cylinder 32, a first rotor 33, a second rotor 34, a drive shaft 35, a drive wheel 36, and a plurality of linking rods 37.

The inner cylinder 31 and the outer cylinder 32 are rotatable about a virtual rotation axis L. Along the rotation axis L, one end of the inner and the outer cylinders 31 and 32 is connected to the first rotor 33, and another end of the inner and the outer cylinders 31 and 32 is connected to the second rotor 34. The inner cylinder 31 defines a plurality of first through holes 313. The first through holes 313 extend through inner and outer surfaces of the inner cylinder 31, connecting the inner and outer surfaces of the inner cylinder 31. The inner cylinder 31 has a mesh structure that includes a plurality of first metal wires 311 braided and defines the plurality of first through holes 313. The inner cylinder 31 encloses a hollow space that forms a heating zone 312. The outer cylinder 32 has a plurality of second through holes 324. The second through holes 324 extend through inner and outer surfaces of the outer cylinder 32, connecting the inner and the outer surfaces of the outer cylinder 32. The outer cylinder has a mesh structure that includes a plurality of second metal wires 321 braided and defines the plurality of second through holes 324. The outer cylinder 32 is arranged circumferentially outside and surrounds the inner cylinder 31. The outer cylinder 32 includes a plurality of reinforcement rings 323 extending thereon. Each of the plurality of reinforcement rings 323 is arranged around an outer periphery of the outer cylinder 32 along the rotation axis L. The plurality of reinforcement rings 323 are abutted against the plurality of second metal wires 321.

A baking zone 322 of the baking device 10 is formed between an outside of the inner cylinder 31 and an inside of the outer cylinder 32. The baking zone 322 is annular and extends outside the inner cylinder 31 and inside the outer cylinder 32. An interface between the bean load pipe 222 and the baking zone 322 is at a higher height than the heater 40. An interface between the bean discharge pipe 223 and the baking zone 322 is at a lower height than the inner cylinder 31.

The first rotor 33 and the second rotor 34 are respectively mounted on the first and the second support portions 21 and 22. One end of the inner cylinder 31 adjacent to the first support portion 21 about the rotation axis L has a first diameter D1, and another end of the inner cylinder 31 adjacent to the second support portion 22 about the rotation axis L has a second diameter D2. The first diameter D1 is smaller than the second diameter D2. One end of the outer cylinder 32 adjacent to the first support portion 21 about the rotation axis L has a third diameter D3. Another end of the outer cylinder 32 adjacent to the second support portion 22 about the rotation axis L has a fourth diameter D4. The fourth diameter D4 is smaller than the third diameter D3. The second rotor 34 is provided with an inner annular portion 341 and an outer annular portion 342. One end of the inner cylinder 31, which is opposite to the first rotor 33, is connected to the inner annular portion 341. One end of the outer cylinder 32, which is opposite to the first rotor 33, is connected to the inner annular portion 341. Moreover, the second rotor 34 is provided with a hollow portion 344 extending outside the inner annular portion 341 and inside the outer annular portion 342. The bean load pipe 222 and the bean discharge pipe 223 are connected to the baking zone 322 through the hollow portion 344.

One end of the drive shaft 35 is connected to the first rotor 33, and the drive wheel 36 is connected to the drive shaft 35. The drive shaft 35 is supported by the shaft seat 211.

One end of the plurality of linking rods 37 is connected to the first rotor 33 and another end of the plurality of linking rods 37 is connected to the second rotor 34. The plurality of linking rods 37 are disposed outside the outer cylinder 32. The plurality of linking rods 37 are spaced at equal angles around the outer cylinder 32. The second rotor 34 is provided with a plurality of bridge portions 343. One end of the plurality of bridge portions 343 is connected to the outer annular portion 342 and another end of bridge portions 343 is connected to the inner annular portion 341. Another end of each of the plurality of linking rods 37 is connected to each of the plurality of bridge portions 343.

The heater 40 is connected to the frame 20 and arranged in the heating zone 312. The heater 40 is supported by the heater seat 221, and an end of the heater 40 passes through the second rotor 34 and is arranged in the heating zone 312. In the embodiment, the heater 40 is an infrared heating lamp.

In view of the above, the baking device 10 is designed to provide consistent and uniform heating throughout the baking process. It ensures that the heat is evenly distributed, resulting in perfectly baked goods every time. Therefore, the baking device 10 can evenly heat coffee beans and does not overheat or burn them. The coffee beans can be placed into the baking zone 322 through the bean load pipe 222. The heater 40 can generate heat to increase the temperature of the baking zone 322. The baking zone 322 is heated indirectly by the heater 40 because the heater 40 is housed inside the inner cylinder 31. This allows for even heating of the coffee beans. Furthermore, the mesh structure of the inner and outer cylinders 31 and 32 enables the roller assembly 30 to continually mix the coffee beans and cooperate with heat convection to maintain a consistent and stable temperature throughout the baking zone 322.

Although specific embodiments have been illustrated and described, numerous modifications and variations are still possible without departing from the scope of the invention. The scope of the invention is limited by the accompanying claims.

1. A baking device with uniform heating application comprising:
a frame;
a roller assembly supported by the frame, wherein the roller assembly comprises an inner cylinder and an outer cylinder rotatable about a virtual rotation axis, wherein the inner cylinder defines a plurality of first through holes, and the first through holes extend through inner and outer surfaces of the inner cylinder, connecting the inner and outer surfaces of the inner cylinder, wherein the inner cylinder encloses a hollow space that forms a heating zone, wherein the outer cylinder has a plurality of second through holes, wherein the second through holes extend through inner and outer surfaces of the outer cylinder, connecting the inner and the outer surfaces of the outer cylinder, wherein the outer cylinder is arranged circumferentially outside and surrounds the inner cylinder, and wherein a baking zone of the baking device is formed between an outside of the inner cylinder and an inside of the outer cylinder; and
a heater connected to the frame and arranged in the heating zone.

2. The baking device as claimed in claim 1, wherein the inner cylinder has a mesh structure that includes a plurality of first metal wires braided and defines the plurality of first through holes, and wherein the outer cylinder has a mesh structure that includes a plurality of second metal wires braided and defines the plurality of second through holes.

3. The baking device as claimed in claim 1, wherein the frame is provided with a first support portion and a second support portion that support the roller assembly, wherein the roller assembly is disposed between the first and the second support portions, wherein the roller assembly comprises a first rotor and a second rotor respectively connected on the first and the second support portions, and wherein along the rotation axis, one end of the inner and the outer cylinders is connected to the first rotor and another end of the inner and the outer cylinders is connected to the second rotor.

4. The baking device as claimed in claim 3, wherein the first support portion includes a shaft seat connected thereto and the shaft seat and the second support portion are disposed on opposite sides of the first support portion, wherein the second support portion includes a heater seat connected thereto and the heater seat and the first support portion are disposed on the opposite sides of the second support portion, wherein the roller assembly comprises a drive shaft and a drive wheel, and one end of the drive shaft is connected to the first rotor, and the drive wheel is connected to the drive shaft, wherein the drive shaft is supported by the shaft seat; and wherein the heater is supported by the heater seat, and an end of the heater passes through the second rotor and is arranged in the heating zone.

5. The baking device as claimed in claim 2, wherein the outer cylinder includes a plurality of reinforcement rings extending thereon, wherein each of the plurality of reinforcement rings is arranged around an outer periphery of the outer cylinder along the rotation axis, and wherein the plurality of reinforcement rings are abutted against the plurality of second metal wires.

6. The baking device as claimed in claim 3, wherein one end of the inner cylinder adjacent to the first support portion about the rotation axis has a first diameter, and another end of the inner cylinder adjacent to the second support portion about the rotation axis has a second diameter, wherein the first diameter is smaller than the second diameter, wherein one end of the outer cylinder adjacent to the first support portion about the rotation axis has a third diameter, wherein another end of the outer cylinder adjacent to the second support portion about the rotation axis has a fourth diameter, and wherein the fourth diameter is smaller than the third diameter.

7. The baking device as claimed in claim 3, wherein the roller assembly comprises a plurality of linking rods and one end of the plurality of linking rods is connected to the first rotor and another end of the plurality of linking rods is connected to the second rotor, wherein the plurality of linking rods are disposed outside the outer cylinder, and wherein the plurality of linking rods are spaced at equal angles around the outer cylinder.

8. The baking device as claimed in claim 7, wherein the second rotor is provided with an inner annular portion and an outer annular portion, wherein one end of the inner cylinder, which is opposite to the first rotor, is connected to the inner annular portion, wherein one end of the outer cylinder, which is opposite to the first rotor, is connected to the inner annular portion, wherein the second rotor is provided with a plurality of bridge portions and one end of the plurality of bridge portions is connected to the outer annular portion and another end of bridge portions is connected to the inner annular portion, and wherein another end of each of the plurality of linking rods is connected to each of the plurality of bridge portions.

9. The baking device as claimed in claim 8 further comprising a bean load pipe and a bean discharge pipe connected to the second support portion, wherein the second rotor is provided with a hollow portion extending outside the inner annular portion and inside the outer annular portion, and wherein the bean load pipe and the bean discharge pipe are connected to the baking zone through the hollow portion.

10. The baking device as claimed in claim 9, wherein an interface between the bean load pipe and the baking zone is at a higher height than the heater, and wherein an interface between the bean discharge pipe and the baking zone is at a lower height than the inner cylinder.

11. The baking device as claimed in claim 1, wherein the heater is an infrared heating lamp.

12. The baking device as claimed in claim 1, wherein the baking zone is annular and extends outside the inner cylinder and inside the outer cylinder.

13. The baking device as claimed in claim 5, wherein the outer cylinder includes a plurality of reinforcement rings extending thereon, wherein each of the plurality of reinforcement rings is arranged around an outer periphery of the outer cylinder along the rotation axis, and wherein the plurality of reinforcement rings are abutted against the plurality of second metal wires.
